(19) United States
(12) Patent Application Publication
(10) Pub. No.: US 2014/0248573 A1
(43) Pub. Date: Sep. 4, 2014

(54) DEVICE FOR HEAT TREATMENT, AND HEAT TREATMENT METHOD

(71) Applicant: Martin Sauter, Sulgen (CH)

(72) Inventor: Martin Sauter, Sulgen (CH)

(73) Assignee: BELIMED AG, Zug (CH)

(21) Appl. No.: 14/343,210

(22) PCT Filed: Aug. 29, 2012
(86) PCT No.: PCT/EP2012/066748

§ 371 Date: May 20, 2014

(30) Foreign Application Priority Data
Sep. 8, 2011 (EP) 11180592.5

(51) Int. Cl. F27D 7/02

(52) U.S. Cl. CPC F27D 7/02
USPC 432/27; 432/197

(57) ABSTRACT

A device for carrying out a heat treatment method with a heat treatment liquid is disclosed. The device includes a working tank, which can be closed in a pressure-tight manner and designed as a hollow circular cylindrical. The interior of the working chamber has a process chamber for arranging material to be treated. The device includes a feed device for feeding a heat treatment liquid into the process chamber and a discharge device for discharging hear treatment liquid present in the process chamber. The device has a circulating device for circulating an amount of the heat treatment liquid within the process chamber for carrying out the heat treatment method. The device includes a heating device for heating the heat treatment liquid and a storage tank for temporarily storing substantially the entire amount of the heat treatment liquid. The storage tank is arranged completely in the interior of the working tank.

The invention relates to a device for carrying out a heat treatment method with a heat treatment liquid, in particular a hot-water sprinkling sterilizer, in accordance with the preamble of claim 1. The invention furthermore relates to a method for heat treatment with a heat treatment liquid, in particular for implementation with the abovementioned device.

Devices such as autoclaves for batchwise heat treatment under moist conditions, such as sterilization, tyndallization or pasteurization, are known in which the material to be treated is sprinkled with hot water in a process chamber that can be closed in a pressure tight manner. Without restriction to specific heat treatment methods, reference will be made below by way of example to devices for sterilization.

In sterilization by means of hot water sprinkling, the process chamber is closed after being charged with the material to be sterilized and is filled with water until a desired water level is reached. No later than this point in time, the water is circulated by a circulating device and fed to a sprinkling device. The sprinkling device distributes the sterilizing water uniformly over the material to be sterilized, by means of nozzles and/or distribution plates for example. Provided in the circuit there is, for example, a heat exchanger, through which a heating medium flows and which brings the water to a desired process temperature. In other embodiments, the sterilizing water can be heated by steam injection, for example. Depending on the application of the device, the preferred process temperature of the sterilizing water can be in a range of from 60 to 90 degrees Celsius (pasteurization), in a range around and up to about 100 degrees (tyndallization) and greater than 100 degrees (sterilization, often at 121 degrees). On conclusion of a holding phase, during which the product is sterilized, tyndallized or pasteurized, the circulating sterilizing water and hence the material to be sterilized can be cooled to a predefined removal temperature. An additional heat exchanger, for example, through which a cooling medium flows, can be provided for cooling in the circuit, or the sterilizing water can be cooled by cold water injection. Following cooling, the sterilizing water is discharged from the process chamber, allowing the latter to be opened to remove the material to be sterilized. In this case, a certain residual quantity of the sterilizing water may remain in the process chamber.

In order to be able to limit water consumption and use residual heat present in the sterilizing water, the prior art discloses devices which have storage vessels for temporary storage of the sterilizing water. DE 40 17 340 A1, for example, describes a device for sterilizing having an external storage vessel, which is connected by a hydraulic system to the process chamber in such a way that sterilizing water can be transferred between the process chamber and the storage vessel and vice versa when required. (E.g. during charging and discharging of the process chamber). Whereas the working tank containing the process chamber is arranged horizontally, the storage vessel is provided in an upright position. Owing to the required storage volume of the storage vessel, the overall height of the device is thus relatively large.

Storage vessels which are arranged horizontally are likewise known. U.S. Pat. No. 4,164,590, for example, describes a corresponding device for heat treating material to be sterilized in a process chamber of a working tank, in which a horizontal storage vessel is arranged above the horizontal working vessel. Such an arrangement above the working vessel has the advantage that the sterilizing water can be conveyed into the working vessel from the storage vessel without additional pumps, solely by virtue of gravity. While this embodiment has a more compact overall volume than corresponding devices with a vertical storage vessel, the overall height of the device is relatively large, as before.

Moreover, irrespective of their arrangement and design, storage vessels of this kind have the disadvantage that they have to be cleaned and, if appropriate, sterilized separately from the working vessel, and this gives rise to additional effort in the maintenance of the device.

It is therefore an object of the invention to overcome the stated disadvantages of the prior art, in particular to make available a device for carrying out a heat treatment method which has a compact construction and a preferably small overall height. At the same time, the device should be simple to maintain and economical and energy-efficient to operate. It is a further object of the invention to make available an economical and energy-efficient method for operating a device of this kind.

According to the invention, these objects are achieved by means of a device which has the features of claim 1 and by means of a method which comprises the method steps as claimed in claim 18.

The invention as claimed in claim 1 relates to a device for carrying out a heat treatment method with a heat treatment liquid, in particular a hot-water sprinkling sterilizer, comprising a working tank, which can be closed in a pressure tight manner and which is preferably designed as a hollow circular cylinder, the interior of which comprises a process chamber for arranging material to be treated. There is furthermore a feed device for feeding a heat treatment liquid into the process chamber, and a discharge device for discharging heat treatment liquid present in the process chamber. There is furthermore a circulating device for circulating a quantity of the heat treatment liquid introduced into the process chamber for carrying out the heat treatment method between the discharge device and the feed device, and a heating device for heating the heat treatment liquid. The device furthermore comprises a storage tank for temporarily storing substantially the entire quantity of the heat treatment liquid introduced into the process chamber for the heat treatment method. The device furthermore has a transfer device for transferring the heat treatment liquid from the process chamber into the storage tank and a return device for returning the heat treatment liquid from the storage tank into the process chamber. According to the characterizing part of claim 1, the device is distinguished by the fact that the storage tank is arranged completely in the interior of the working tank.

The working tank is preferably designed as a hollow circular cylinder, in the interior of which the process chamber is arranged and which is closed off at the ends by end walls. It is advantageous if, in the operational condition, the working tank is aligned with a longitudinal axis substantially horizontal in order to ensure a uniform level in relation to said longitudinal direction. Depending on the application (pasteurization, sterilization etc.), the working tank can be designed for different internal pressures (e.g. a vacuum or excess pressure). The working tank preferably has a hinged door, which pressure tightly closes a working tank opening formed in one of the end faces. It is advantageous if the opening is dimensioned in such a way that at least the process chamber is accessible over its entire cross section, thus enabling transport pallets with material to be treated arranged thereon, for example, to be introduced in a simple manner.

The feed device preferably comprises a feed opening, which is advantageously arranged in an upper region of the working tank, in particular in an upper region of the process chamber. In the case of a sprinkling sterilizer, the feed opening can be connected directly to a sprinkling device, by means of which the heat treatment liquid fed in can be sprinkled and/or sprayed in a uniformly distributed manner over the process chamber. For this purpose, the sprinkling device preferably comprises distributing plates and/or nozzles.

The discharge device preferably comprises a collecting tank or a collecting trough, by means of which the heat treatment liquid can be collected for discharge from the process chamber. The discharge device is connected to the circulating device by pipes and/or valve devices, for example. The discharge device is furthermore preferably connected to an external outflow, via which the heat treatment liquid can be discharged completely if required.

The circulating device generally comprises a circulating pump, by means of which the heat treatment liquid introduced into the process chamber can be delivered from the discharge device to the feed device. For this purpose, corresponding pipes and/or valve devices, by means of which the flow can be controlled and/or directed, are furthermore provided.

The quantity of heat treatment liquid introduced into the process chamber differs according to the application. In the case of pasteurization, for example, the material to be treated is generally completely flooded, while, in the case of hot-water sterilization, the material is generally not covered. The specific quantity of heat treatment liquid to be introduced for the particular mode of operation is known to a person skilled in the art and does not require any further explanation here. It is self-evident that the circulating device must be adapted to the specific requirements if necessary.

For heating the heat treatment liquid, the circulating device preferably comprises a heating device, which is advantageously provided with a heat exchanger for exchanging heat energy with an externally supplied hot medium, e.g. steam.

The storage tank is dimensioned in such a way that preferably substantially the entire quantity of heat treatment liquid introduced into the process chamber for the heat treatment method can be held by the storage tank. This enables the process chamber to be emptied completely if required without the need for disposal and hence loss of the heat treatment liquid. As mentioned above, the specific quantity of heat treatment liquid differs according to the intended use of the device, for which reason the volume of the storage tank must be adapted accordingly if necessary. It is self-evident that it may not be necessary to transfer the entire quantity of heat treatment liquid into the storage tank for removal or introduction of the material to be treated but that a certain level can remain or is desired in the process chamber.

To transfer the heat treatment liquid from the process chamber into the storage tank, the transfer device preferably comprises pipes and/or valve devices, by means of which it is connected to the circulating device. In this case, the transfer device can advantageously be designed to at least partially overlap with the circulating device, i.e. the two devices can comprise common components, allowing synergies to be exploited and redundancies in the hydraulic system to be reduced. However, it is self-evident that the transfer device can also be designed as a separate hydraulic system with its own pumping device, for example.

There is a return device for returning the heat treatment liquid from the storage tank into the process chamber. Given suitable arrangement of the storage tank in the working tank, this can comprise just one valve device, for example, as a particularly simple option, in order to be able to discharge the heat treatment liquid directly from the storage tank into the process chamber by virtue of gravity. It is self-evident that, in other embodiments, the return device can also comprise a pump.

According to the invention, the storage tank is arranged in the interior of the working tank. This ensures that the overall volume, in particular the overall height, of the device is determined substantially by the dimensioning of the working tank, and that an additional external tank is not required. Here, it is possible, in particular, to make efficient use of dead spaces in the interior of the working tank resulting, for example, from the circular-cylindrical shape of the working tank and from a generally rectangular cross section of the process chamber. Given a suitable design and arrangement of the storage tank, said storage tank can thus be accommodated in the working tank without prejudicing a volumetric capacity of the process chamber. Moreover, the storage tank can be sterilized in a single operation together with the working tank if required, it being possible for this sterilization to take place automatically during the execution of the corresponding method in the case of a sterilizer.

Moreover, it is also possible to make constructive use of synergies if, for example, the working tank and the storage tank have common tank walls, not least among the advantages being the saving in the costs of materials. Moreover, the structural integrity of the working tank can also be increased by the storage tank being formed therein. In particular, the working tank and the storage tank can jointly form an integral structure as a welded steel construction.

Not least, the integrated storage tank also offers complete integration of the media relevant to the process in the working tank. Thus, feeding in and discharging the heat treatment liquid from the process chamber into the storage tank and vice versa is particularly simple. In particular, connecting pipes can be kept short and, at least in part, can likewise be arranged in the working tank. This is advantageous both from a design point of view and in relation to energy efficiency and the maintenance of the device.

The feed device advantageously comprises a sprinkling device, which is designed for uniform sprinkling of material to be treated, which is arranged in the process chamber, with the heat treatment liquid. In particular, the sprinkling device can comprise nozzles and/or distributing plates, wherein the heat treatment liquid can preferably be introduced into the process chamber from above but also optionally in addition or exclusively from the sides.

In a preferred embodiment, the return device is designed in such a way that the storage tank can be connected fluidically to the circulating device via the return device, thus enabling the heat treatment liquid to be returned to the process chamber from the storage tank via the circulating device. The return device preferably comprises pipes and/or valve devices, by means of which it is connected to the circulating device. It is advantageous if the transfer device is designed to overlap partially with the circulating device, making it possible to exploit synergies and ensuring the minimum possible redundancies in the hydraulic system. However, it is self-evident that the return device can also be designed as a separate hydraulic system with, for example, a separate pump.

However, in an embodiment which is likewise preferred, depending on requirements, the return device is designed in such a way that the storage tank can be connected directly to the process chamber via the return device. In particular, the storage tank is arranged in such a way in the interior of the working tank and the return device is designed in such a way that the heat treatment liquid can flow into the process chamber via the return device owing to gravity when the storage tank is connected fluidically to the process chamber via the return device. This provides a passive system which allows the process chamber to be supplied with a desired quantity of heat treatment liquid from the storage tank in a simple manner without expenditure of energy.

A return device of this kind preferably comprises a valve device arranged in the interior of the working tank. This enables the return device to be arranged, preferably completely, in the interior of the working tank. A valve device designed as a simple outlet valve on the storage tank is generally sufficient to establish a fluid connection between the storage tank arranged in the interior of the working tank and the process chamber in a simple manner. Owing to the arrangement in the interior, the valve device is furthermore sterilized together with the working tank, like the storage tank, further simplifying maintenance of the device.

Depending on requirements, the return device can also advantageously comprise a valve device arranged outside the working tank. In this case, the valve device is accessible from outside and can be actuated or serviced, e.g. manually. For this purpose, however, piping from the storage tank to the outside and from the valve device to the process chamber is required, and although this is more complex in terms of design it may be preferred due to the advantages stated, depending on requirements.

As already mentioned at the outset, the transfer device can overlap at least partially with the circulating device. In a preferred embodiment, the circulating device therefore comprises a valve arrangement, by means of which a heat treatment medium discharged by the discharge device can be fed either for circulation to the feed device or, via the transfer device, for transferring to the storage tank. In this case, the transfer device can be designed as a simple branch of the circulating device, the branch being controllable by means of the valve device and opening into the storage tank.

As mentioned at the outset, the circulating device advantageously comprises a heat exchanger for heating the heat treatment medium during circulation and preferably has a further heat exchanger for cooling the heat treatment medium during circulation. Providing two separate heat exchangers for heating and cooling enables these components to be optimized for the respective requirement. In principle, however, it is also conceivable to provide just one heat exchanger for optional heating or cooling or to achieve heating and cooling in some other way, e.g. by steam or cold water injection. In the latter case, however, there is a continuous variation in the quantity of heat treatment liquid in the circulating circuit, thus necessitating continuous compensation of a level by feeding in or discharging heat treatment liquid.

In a particularly advantageous design the storage tank is constructed on an inner wall of the working tank, wherein the inner wall of the working tank advantageously forms part of a wall of the storage tank. This means, on the one hand, that dual use can be made of design elements as a tank wall, and, on the other hand, that the storage tank can simultaneously serve as a reinforcement for the working tank wall.

In this case, the storage tank can be designed in such a way that an interior of the storage tank communicates with the interior of the working tank, in particular being open in an upper region. This is associated with the advantage that the interior of the storage tank is easily accessible and receives the same servicing during maintenance, e.g. cleaning or sterilization of the interior of the working tank, without special measures.

As an alternative, an embodiment in which the interior of the storage tank can be closed off fluid tightly with respect to the interior of the working tank may likewise be advantageous, depending on the requirements. This is necessary, for example, if the return of the heat treatment liquid from the storage tank into the process chamber requires subjecting the interior of the storage tank to an excess pressure.

As already mentioned at the outset, the working tank is advantageously designed as a substantially elongate circular cylinder, wherein the process chamber extends along the longitudinal direction of the working tank and has a substantially rectangular cross section. It is self-evident that the working tank can also have some other, substantially arbitrary shape, being, for example, oval-cylindrical or, alternatively, cuboidal or cubic. However, a circular-cylindrical shape has design advantages and is particularly stable from a structural point of view.

The storage tank advantageously has a cross section substantially in the form of a circular segment and is arranged in a region between the process chamber and the wall of the working tank. In the case of a circular-cylindrical working tank, in particular, the storage tank can be designed to nestle the inner wall and can optimally fill a dead space between the process chamber and the working tank wall. Here, substantially in the form of a circular segment also includes, in particular, shapes of circular segment with capped corners. In this case, the sections of the walls of the storage tank preferably at least partially delimit the process chamber. Thus, the wall of the storage tank can at least partially perform a dual function, and a particularly simple design is thereby achieved.

The storage tank preferably extends substantially over the entire length of the interior of the working tank. Optimum use is thus made of the fundamentally available space in the working tank, thus allowing a maximum possible quantity of heat treatment liquid to be held in the storage tank.

If a particularly large storage volume of the storage tank is required, a further storage tank can advantageously be present in the interior of the working tank, said further storage tank preferably being arranged opposite the first storage tank with respect to the longitudinal axis of the working tank, and being of substantially identical construction, preferably a mirror image. Particularly in the case of a working tank of circular-cylindrical design with a process chamber of rectangular cross section, it is possible in this way to accommodate at least two storage tanks in advantageous manner in the dead spaces. Depending on requirements, the two storage tanks can communicate with one another or can be designed as separate tanks closed off from one another.

The storage tank preferably comprises a heating device, by means of which the heat treatment liquid can be heated to prevent microbial contamination when it is stored temporarily in the storage tank. The heat treatment liquid can thereby be kept sterile while the process chamber is being charged or discharged, for example.

The device according to the invention also permits the carrying out of a particularly advantageous method for heat treatment with a heat treatment liquid. According to the invention, the method comprises the following steps:

a) introducing material to be treated into a process chamber of a working tank,

b) introducing a quantity of heat treatment liquid required for carrying out the method from a storage tank arranged in the working tank into the process chamber,

c) heated circulation of the heat treatment liquid by means of a circulating device between a discharge device for discharging heat treatment liquid from the process chamber and a feed device for feeding heat treatment liquid into the process chamber, wherein the heat treatment liquid is heated to a process temperature,

d) transferring a significant amount of the heat treatment liquid present in the process chamber into the storage tank arranged in the working tank,

e) if appropriate, discharging some of the heat treatment liquid and compensating a level in the storage tank by feeding in additional heat treatment liquid from the outside.

During the heated circulation of the heat treatment liquid, the liquid is heated to a process temperature of 60 to 90 degrees Celsius (pasteurization), in a range around and up to a maximum of about 100 degrees (tyndallization) or to more than 100 degrees (sterilization), depending on the type of process. In the case of sterilization, it is preferably heated to 121 degrees Celsius. Typically, heated circulation takes place for about 20 minutes. In the case of tyndallization, the corresponding values are typically 30 minutes and 100 degrees Celsius. It is self-evident that these values can vary depending on the specific requirements.

According to the invention, the quantity of the heat treatment liquid which is required to carry out the method is introduced into the process chamber from the storage tank arranged in the working tank. Also according to the invention the transfer of a significant amount of the heat treatment liquid present in the process chamber takes place into the storage tank arranged in the working tank. In this way, transfer of the heat treatment liquid between the process chamber and the storage tank can be achieved in a particularly simple manner. Further advantages relating to the method result directly from the advantages already described in connection with the device.

After heated circulation, the method can advantageously comprise an additional step, in which the heat treatment liquid is cooled to a desired removal temperature during the circulation of the heat treatment liquid by means of the circulating device between the discharge device and the feed device of the process chamber (cooled circulation). The material to be treated is thereby brought from the process temperature to a removal temperature, at which the material can be removed from the process chamber. Typical values for the removal temperature are in a range of from 30 to 90 degrees Celsius. The time for this step depends inter alia on the temperature difference between the process temperature and the desired removal temperature and can therefore vary.

The feed device is preferably designed as a sprinkling device for uniform sprinkling of material to be treated, which is arranged in the process chamber, with the result that, in the circulation step, material to be treated, which is arranged in the process chamber, is advantageously sprinkled uniformly with the heat treatment liquid by means of the feed device. This ensures that all the material to be treated is brought uniformly to the desired temperature.

It is advantageous if the circulating device feeds the heat treatment liquid to the storage tank via a transfer device during the transfer of the heat treatment liquid into the storage tank. Since the method also uses the circulating device for transfer, particularly good efficiency is achieved.

During the introduction of the heat treatment liquid into the process chamber from the storage tank, the storage tank is preferably connected fluidically to the circulating device via a return device and the heat treatment liquid is introduced into the process chamber from the storage tank via the circulating device and the feed device. This version of the method has recourse to the circulating pump for another function, thereby making particularly efficient use of components of the device which are present in any case.

As an alternative, it is possible, during the introduction of the heat treatment liquid into the process chamber from the storage tank, for the storage tank to be connected fluidically directly to the process chamber via a return device, e.g. by opening a valve device of the return device. The heat treatment liquid then flows out of the storage tank into the process chamber via the return device, preferably owing to gravity alone. This version has the advantage that there is no need for a pump and hence no need for any energy to introduce the heat treatment liquid into the process chamber from the storage tank.

As already mentioned at the outset, it is particularly advantageous to use a heat treatment liquid which consists substantially of water. In particular, the heat treatment liquid can consist exclusively of water (of course containing impurities of the kind found in mains water for example). This gives a low-cost version, and the heat treatment liquid can be supplemented from external sources without major outlay. It is self-evident that additions of disinfectants or ozonification of the water can be carried out if required. It is likewise also possible to use other suitable heat treatment liquids if the specific requirements make this necessary.

Further advantages and individual features of the invention are illustrated in the drawings and are described below. In the schematic drawings:

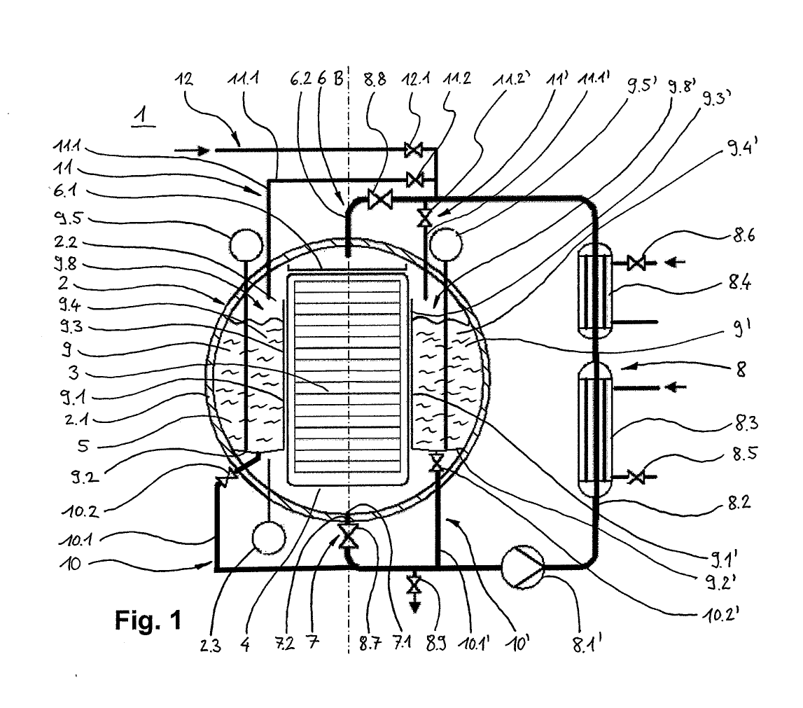

FIG. 1 shows a first embodiment of a device according to the invention for carrying out a heat treatment method in a cross-sectional view;

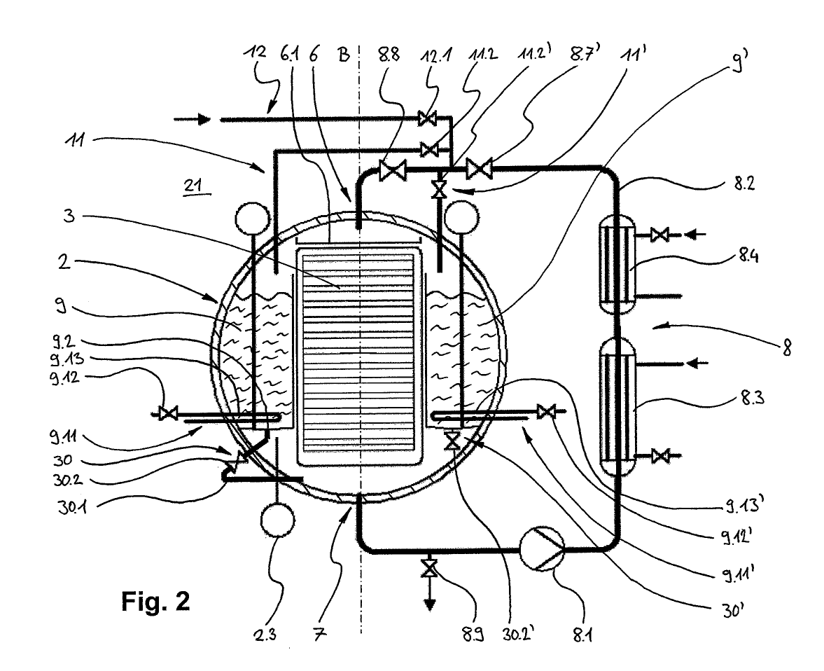

FIG. 2 shows an illustration, similar to that in FIG. 1, of another embodiment of a device according to the invention;

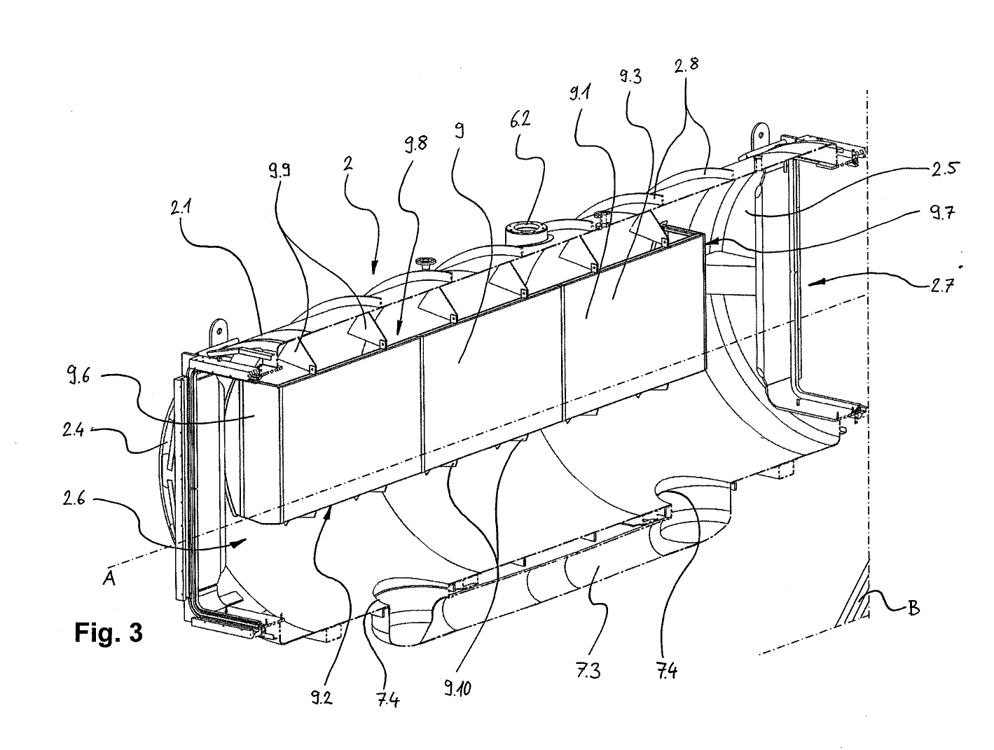

FIG. 3 shows a longitudinal section through a working tank of a device according to the invention;

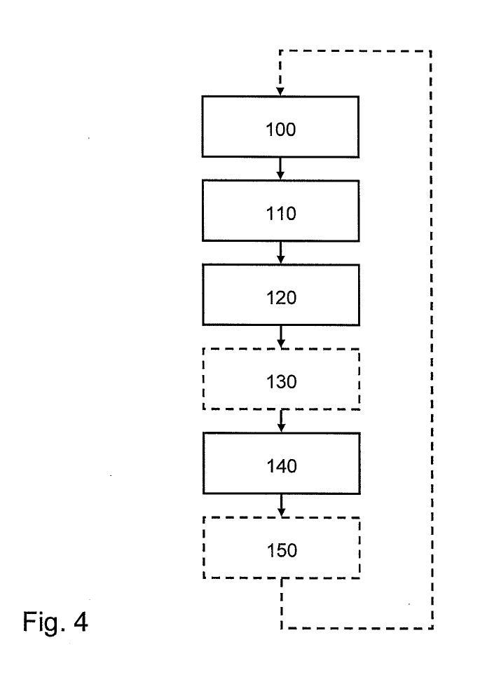

FIG. 4 shows a flow diagram of the method according to the invention.

In the figures, fundamentally identical parts are provided with identical reference signs.

FIG. 1 shows a schematic illustration of a first embodiment of a device 1 according to the invention for carrying out a heat treatment method in a cross section perpendicular to a longitudinal axis A of a working tank 2 of circular-cylindrical design. The device 1 shown in FIG. 1 is provided, in particular, as a sterilizer for sprinkling material 3 to be sterilized with hot water. In the context of the present description of the invention, reference is made to directions such as up, down, sideways, horizontally and vertically. These directions should be understood as relative to an operational arrangement of the working tank 2 or of the device 1, wherein an operational arrangement of the device 1 is determined by the gravity-induced direction of flow or direction of falling of water (vertical). In the present case, the working tank 2 is arranged with its longitudinal axis A substantially horizontal in the operational state.

The working tank has a circular-cylindrical tank wall 2.1, which delimits an interior 2.2 of the working tank 2. In the interior 2.2 is a region of rectangular cross section which extends in the longitudinal direction A over the entire length of the working tank 2 and which is designed as a sterilizing chamber 4 (autoclave). The material 3 to be sterilized is arranged in the sterilizing chamber 4 while the sterilization process is carried out. It is self-evident that the sterilizing chamber 4 does not have to be designed as a closed chamber in the interior 2.2. On the contrary, the sterilizing chamber 4 denotes a spatial zone in the interior 2.2 of the working tank 2 which is provided for the arrangement of the material 3 to be sterilized and for sprinkling with sterilizing water 5.

In the longitudinal direction A, the interior 2.2 of the working tank 2 is closed off at the ends by end walls 2.4 and 2.5 (not shown in FIG. 1, see FIG. 3). An opening 2.6 (2.7), which can be closed in a pressure tight manner by means of a door, is formed in at least one of the end walls 2.4 (2.5) (see FIG. 3), and the material 3 to be sterilized can be introduced into the sterilizing chamber 4 through this opening. It is advantageous if a corresponding opening 2.6, 2.7 is formed in the two end walls 2.4 and 2.5, respectively. In this case, one of the openings can always be provided for the removal of already sterilized material and the other can always be provided for the introduction of fresh, as yet unsterilized material. When the removal opening is open, the introduction opening is preferably closed. After the removal of the already sterilized material, the removal opening is closed and only then is the introduction opening opened to introduce unsterilized material into the sterilizing chamber 4. In such an operating mode, in the manner of a lock, contamination of already sterilized material during removal can be prevented as far as possible (the removal side is the sterile side and the introduction side is the non-sterile side). It is self-evident that both openings 2.6 and 2.7 can also be opened simultaneously for maintenance purposes, for example.

Arranged above the sterilizing chamber 4 is a feed device 6, which comprises a sprinkling device 6.1, which is arranged in the interior 2.2 of the working tank 2, and a pipe conduit section 6.2. The pipe conduit section 6.2 passes through the tank wall 2.1, allowing sterilizing water 5 to be introduced into the working tank 2 from the outside via the pipe conduit 6.2. The pipe conduit 6.2 is connected to the sprinkling device 6.1, thus enabling the sterilizing water 5 fed in to be sprinkled and/or sprayed in a manner uniformly distributed over the sterilizing chamber 4 via the sprinkling device 6.1. For this purpose, the sprinkling device 6.1 has nozzles and/or distributing plates or elements with a similar action, for example.

A discharge device 7 for discharging accumulated sterilizing water 5 from the working tank 2 is formed underneath the sterilizing chamber 4. The discharge device 7 is preferably arranged at the lowest point of the interior 2.2 and has a discharge opening 7.1, which is connected to a pipe conduit section 7.2. The discharge device 7 can also comprise a separate collecting tank 7.3 (not shown in FIG. 1, see FIG. 3), which is arranged in a lower region of the working tank 2, preferably underneath the sterilizing chamber 4, which communicates with the sterilizing chamber 4 and to which the pipe conduit 7.2 is connected.

The pipe section 7.2 passes through the tank wall 2.1, thus enabling sterilizing water 5 to be discharged to the outside from the working tank 2 via the pipe conduit 7.2. In the interior 2.2, there is a level indicator 2.3, by means of which a level of sterilizing water 5 in the working tank 2 can be monitored.

Arranged between pipe section 6.2 of the feed device 6 and pipe section 7.2 of the discharge device 7 there is a circulating device 8 comprising a circulating pump 8.1, which connects the two pipe sections 6.2 and 7.2 to one another via a pipe conduit 8.2. Here, the pump 8.1 is arranged in pipe conduit 8.2 in such a way that a pumping direction is from pipe conduit 7.2 to pipe conduit 6.2. It is self-evident that the pump 8.1 can additionally also be designed to operate in the opposite direction. Pipe conduit 8.2 is connected to pipe section 7.2 via a valve device 8.7 and to pipe section 6.2 via a valve device 8.8.

The circulating device 8 has heat exchangers 8.3 and 8.4, which are arranged in series relative to a direction of flow in pipe conduit 8.2. A first heat exchanger 8.3 in the direction of flow can be supplied from outside with a cooling medium, thus allowing the sterilizing water 5 flowing in pipe conduit 8.3 to be cooled. The second heat exchanger 8.4 in the direction of flow can be supplied with a heating medium, by means of which the sterilizing water 5 flowing in pipe conduit 8.3 can be heated. Each of the heat exchangers 8.3 and 8.4 has a valve device 8.5 and 8.6, respectively, via which an inflow of the cooling medium and of the heating medium, respectively, can be controlled.

Between valve device 8.7 and circulating pump 8.1, a branch of pipe conduit 8.2 is connected via a valve device 8.9 to an external outflow, allowing the sterilizing water 5 in pipe conduit 8.2 to be discharged if required.

Two storage tanks 9 and 9′ are arranged in the interior of the working tank 2. In the illustration in FIG. 1, all the sterilizing water 5 is present in the storage tanks 9 and 9′. The storage tanks 9 and 9′ are of symmetrical design with respect to a vertical plane B in which the longitudinal axis A is arranged. Only storage tank 9 is therefore described in detail below.

Storage tank 9 is arranged in a region between the tank wall 2.1 and the sterilizing chamber 4. Storage tank 9 comprises a tank wall 9.1 which is substantially L-shaped in cross section and is arranged in the longitudinal direction A. Tank wall 9.1 has a bottom section 9.2 aligned substantially horizontally. The bottom section 9.2 extends substantially horizontally in a direction toward plane B from an inner side of tank wall 2.1. In cross section, the bottom section 9.2 forms a short arm of the L shape. Adjoining a longitudinal edge of the bottom section 9.2 remote from tank wall 2.1, there is a side wall section 9.3 of tank wall 9.1 which extends upward in a vertical direction, i.e. is arranged substantially at right angles to the bottom 9.2. Here, the side wall section 9.3 forms a long arm of the L shape in cross section.

At its upper longitudinal edge, the side wall 9.3 is free and spaced apart from the inner side of tank wall 2.1. In this case, the side wall 9.3 is aligned substantially parallel to the plane B and delimits the sterilizing chamber 4 in a direction perpendicular to B (see FIG. 3). In longitudinal direction A, storage tank 9 is closed off at the ends by end faces 9.6 and 9.7 (see FIG. 3). Thus, an interior 9.4 of storage tank 9 which is closed at the bottom and open on an upper side 9.8 and which is delimited by tank wall 2.1, the side wall 9.3 and the end walls 9.6 and 9.7 is obtained. There is a level indicator 9.5 in storage tank 9 to monitor a level in the interior 9.4.

Storage tank 9′ has a tank wall 9.1′ of substantially corresponding design to tank wall 9.1 (albeit a mirror image relative to the plane B), having a bottom 9.2′ and a side wall 9.3′. In a similar way, therefore, there is an upwardly open interior 9.4′ of storage tank 9′ between tank wall 2.1 and storage tank wall 9.1′, said interior being closed off in the longitudinal direction A by end walls 9.6′ and 9.7′. To monitor a level in the interior 9.4′, there is also a level indicator 9.5′ in storage tank 9′.

In principle, it is conceivable to construct the two storage tanks 9 and 9′ so that they communicate with one another, with the result that a single level indicator and a single return device with just one pipe conduit and just one valve device is sufficient, for example. It is likewise possible for the tank walls of the storage tanks to be designed with a U-shaped cross section, wherein the two arms of the U shape are arranged substantially horizontally and are secured by their free ends on tank wall 2.2 of the working tank 2. In this case, a lower arm corresponds to the bottom of the storage tank, while the other arm corresponds to a cover and the base of the U-shape corresponds to a vertically arranged side wall. It is thus possible to provide storage tanks which are closed off from the interior 2.2 of the working tank 2, that is to say which are also closed on an upper side, in contrast to the storage tanks 9 and 9′.

In the bottom 9.2, tank wall 9.1 has a slight longitudinal downward kink aligned in longitudinal direction A in order to define a lowest point in the storage tank 9. A pipe conduit 10.1 of a return device 10 is connected in the region of the kink, said pipe conduit communicating with the interior 9.4 of the storage tank 9, leading out of the working tank 2 and opening into pipe conduit 8.2 immediately after the valve 8.7. Arranged in pipe conduit 10.1, outside the working tank 2, is a valve device 10.2, by means of which pipe conduit 10.1 can be opened or closed.

Like pipe conduit 10.1, a corresponding pipe conduit 10.1′ of a return device 10′ is connected to storage tank 9′ and likewise leads out of the working tank 2 and opens into pipe conduit 8.2 directly after the branch containing valve 8.9. In contrast to pipe conduit 10.1, pipe conduit 10.1′ has a valve device 10.2′ which is arranged within the working tank 2 and which is connected essentially directly to storage tank 9′. It is self-evident that it is also possible for both valve devices 10.2 and 10.2′ to be arranged within the working tank 2 or for both to be arranged outside the working tank 2.

Transfer devices 11 and 11′ are connected just ahead of the valve device 8.8 of pipe conduit 8.2. The transfer devices 11 and 11′ each comprise a pipe conduit 11.1 and 11.1′, respectively, said conduits branching at a double branch and leading into the working tank 2. The pipe conduits 11.1 and 11.1′ each open above the respective storage tanks 9 and 9′ in such a way that sterilizing water and 5 fed in through the pipe conduits 11.1 and 11.1′ is caught in the storage tanks 9 and 9′ and collected there. In the case of storage tanks (not shown) which are closed off from the interior 2.2, the pipe conduits 11.1 and 11.1′ lead through the corresponding upper sides of the storage tanks into the interior of the respective storage tanks.

Just after the double branch in conduit 8.2, pipe conduits 11.1 and 11.1′ each have a valve devices 11.2 and 11.2′ arranged outside the working tank 2, by means of which pipe conduits 11.1 and 11.1′ can be opened or closed with respect to pipe conduit 8.2. A connection 12 containing a valve device 12.1 for feeding external fresh water into pipe conduit 8.2 likewise opens in the region of the double branch.

A method for sterilizing material to be sterilized with the device 1 described can proceed as follows:

The material 3 to be sterilized is first of all introduced into the sterilizing chamber (autoclave) 4. The working tank 2 is then locked.

In the hot-water sprinkling method, a predefined quantity of sterilizing water 5 is introduced into the sterilizing chamber 4. At the beginning of the process, the sterilizing water 5 can be introduced as fresh water into the sterilizing chamber 4 from connection 12 via valves 12.1 and 8.7, through pipe conduit 8.2 and via the discharge opening 7.1. In this case, the fresh water is delivered through pipe conduit 8.2 counter to the direction of flow during circulation, for which purpose valves 11.2, 11.2′ and 8.8, 10.2 and 10.2′ as well as 8.9 are closed.

If storage tanks 9 and 9′ already contain sterilizing water 5 from a previous sterilization process, this water can alternatively be introduced into the working tank 2 from storage tanks 9 and 9′ via return devices 10 and 10′ respectively. For this purpose, the sterilizing water 5 from storage tanks 9 and 9′ is passed into the sterilizing chamber 4 via valves 10.2 and 10.2′, the circulating device 8 and valve 8.8. During this process, valves 11.2 and 11.2′ as well as 12.1 and 8.9 are closed.

If a single storage tank, e.g. storage tank 9, is sufficient, the other storage tank, e.g. storage tank 9′, together with the associated fittings, e.g. the return device 10′, can be omitted.

The sterilizing water 5 is then circulated across the material 3 to be sterilized, via the sprinkling device 6.1, by means of the circulating pump 8.1. During this process, valves 8.7 and 8.8 are open, while valves 11.2 and 11.2′, 10.2 and 10.2′ as well as 8.9 are closed. If compensation of the level is required, fresh water can also be fed in via valve 12.1 during circulation and, otherwise, said valve is generally closed during circulation.

The sterilizing water 5 is passed on via pipe conduit 8.2 through heat exchanger 8.4, by means of which the circulated sterilizing water 5 is heated indirectly to a predefined process temperature. During this process, the valve 8.6 for feeding in the heating medium is open (valve 8.5 is closed). During sterilization, the process temperature is more than 100° C., typically 121° C., while, in the case of tyndallization, the sterilizing water 5 is typically heated to about 100° C. Steam can be used as a heating medium, for example.

On conclusion of a holding phase, during which the material 3 to be sterilized is sterilized (or tyndallized or pasteurized) at the desired process temperature, the circulated sterilizing water 5 and hence the material 3 to be sterilized is cooled to a predefined removal temperature (generally between 30° C. and 90° C.) by means of the heat exchanger 8.3. For this purpose, valve 8.5 is opened to feed in the cooling medium, while valve 8.6 is closed.

On completion of cooling, the sterilizing water 5 is either discharged into the waste water via valve 8.7 or is fed back into the storage tanks 9 and 9′ integrated into the working tank 2 for reuse via valves 11.2 and 11.2′ of the transfer devices 11 and 11′, respectively. In this case, valve 8.8 is closed. For this purpose, it is possible to use the circulating pump 8.1, which pumps the sterilizing water 5 out of the sterilizing chamber 4 via valve 8.7 and feeds it to the transfer devices 11 and 11′.

If required, the storage tanks 9 and 9′ are refilled with fresh water to a predefined level via valves 12.1, 11.2 and 11.2′. To ensure that the sterilizing water 5 in the storage tanks 9 and 9′ does not become contaminated with microbes, it can be heated in the storage tanks 9 and 9′ to a temperature in a range of about 60 to 90° C., typically about 80° C. For this purpose, a heating device can be provided in the storage tanks (not shown in FIG. 1, see FIG. 2).

Residual water remaining in the sterilizing chamber 4 can be left either at the bottom of the working tank 2 or, where present, in the collecting tank 7.3 of the discharge device 7 (see FIG. 3) if there is subsequently another sterilization process. Alternatively, the sterilizing chamber 4 or working tank 2 can be completely emptied via valves 8.7 and 8.9. The working tank 2 is then opened and the material 3 to be sterilized can be removed.

FIG. 2 shows a schematic illustration of another embodiment of a device 21 according to the invention, said illustration being similar to the view in FIG. 1. Device 21 differs from device 1 essentially in the design of the return devices 10 and 10′. In the text which follows, only the differences with respect to device 1 are described, while attention is drawn to FIG. 1 for the other, identically designed components (with the same reference signs).

Instead of the pipe conduit 10.1 of return device 10, a return device 30 of device 21 comprises a pipe conduit 30.1, which is likewise connected to storage tank 9 in the region of the kink and communicates with the interior 9.4 of storage tank 9. Pipe conduit 30.1 leads out of the working tank 2 through tank wall 2.1 and back into the working tank 2 at a lower point. In the interior 2.2, pipe conduit 30.1 opens in the region of the sterilizing chamber 4. In a region outside the working tank 2 there is a valve device 30.2 in pipe conduit 30.1, by means of which a fluid passage through pipe conduit 30.2 can be closed or opened. In this case, pipe conduit 30.1 is designed in such a way that the sterilizing water 5 flows from storage tank 9 through pipe conduit 30.1 owing to gravity, being provided with a continuous gradient for example. In this way, the sterilizing water 5 in storage tank 9 can be introduced into the sterilizing chamber 4 without a pump solely by virtue of gravity, simply by opening the valve 30.2

Instead of the pipe conduit 10.1′ of return device 10′, there is, in contrast to device 1, a valve device 30.2′ of a return device 30′ connected directly to the kink of the second storage tank 9′, said valve device being arranged within the working tank 2. In this case, valve device 30.2′ opens directly into the interior 2.2 of the working tank 2. The valve device 30.2′ thus forms an outflow of the storage tank 9′, which allows direct discharge of sterilizing water present in storage tank 9′ into the sterilizing chamber 4.

Since, therefore, no pipe conduits (such as pipe conduits 10.1 and 10.1′ as in FIG. 1) open into pipe conduit 8.2 in the region of the discharge device 7 in device 21, there is also no need for a valve device 8.7. Pipe conduit 8.2 of device 21 is therefore connected directly to pipe conduit section 7.2, in contrast to device 1.

On the other hand, pipe conduit 8.2 of device 21 has an additional valve device 8.7′ in the region ahead of the double branch in the direction of flow in pipe conduits 11.1 and 11.1′ of transfer devices 11 and 11′, said valve device enabling pipe conduit 8.2 to be shut off ahead of the branch.

As already mentioned in connection with FIG. 1, the storage tanks 9 and 9′ can be provided with a heating device in order to heat up sterilizing water 5 stored temporarily in storage tanks 9 and 9′ to about 80° C. (in the range 60-90° C.) in order to prevent microbial contamination. The storage tanks 9 and 9′ of device 21 are therefore each provided with a heating device 9.11 and 9.11′, which allows a heating medium to be fed into a heating element 9.13 or 9.13′ arranged in the respective storage tank 9 or 9′ via a valve device 9.12 or 9.12′.

A method for sterilizing material to be sterilized by means of the device 21 described can proceed in a manner largely similar to the method involving device 1. The different method steps associated with the different structural design are described below. The other method steps take place in a manner similar to that described above:

In device 21, the sterilizing water 5 can either be fed into the sterilizing chamber 4 directly as fresh water from connection 12 via valves 12.1 and 8.7′, via the discharge opening 7.1, at the beginning of the process. During this process, valves 11.2 and 11.2′, 8.8 and 8.9 are closed.

If storage tanks 9 and 9′ already contain sterilizing water 5 from a previous sterilization process, this water can alternatively be introduced into the working tank 2 or sterilizing chamber 4 from storage tanks 9 and 9′ via return devices 30 and 30′ respectively. For this purpose, the sterilizing water 5 from storage tanks 9 and 9′ is discharged directly via valves 30.2 and 30.2′ into the sterilizing chamber 4 by virtue of gravity.

As in the case of device 1, a single storage tank, e.g. storage tank 9, may be sufficient here too, making it possible to dispense with the other storage tank, e.g. storage tank 9′.

The sterilizing water 5 is then circulated across the material 3 to be sterilized, via the sprinkling device 6.1, by means of the circulating pump 8.1. During this process, valves 8.7′ and 8.8 are open, while valves 11.2 and 11.2′ as well as 8.9 are closed.

In order to transfer the sterilizing water 5 into storage tanks 9 and 9′ for reuse after the holding phase and cooling, valve 8.8 is closed, while valves 8.7′ and 11.2 and 11.2′ are opened. Valves 12.1 and 8.9 as well as valves 30.2 and 30.2′ are likewise closed. By means of the circulating pump 8.1, it is thus possible to pump the sterilizing water 5 out of the sterilizing chamber 4 into storage tanks 9 and 9′. Storage tanks 9 and 9′ can then be refilled with fresh water to a predefined level via valve 12.1, with valves 11.2 and 11.2′ being opened and valves 8.7′, 8.8 being closed.

The other method steps correspond essentially to the method steps described in connection with device 1.

FIG. 3 shows a section through a working tank 2 of a device 1 or 21 according to the invention in the plane B, which is arranged vertically and in which the longitudinal axis A extends.

The working tank 2 is closed off at the ends by respective end walls 2.4 and 2.5. An opening 2.6 and 2.7, respectively, is formed in each of the two end walls 2.4 and 2.5, the opening corresponding substantially in cross section to a cross section of the sterilizing chamber 3 and being closable in a pressure tight manner by means of a door (not shown).

Storage tank 9 is arranged on the inside of tank wall 2.1. The interior 9.4 of storage tank 9 is delimited in the transverse direction, i.e. perpendicularly to the longitudinal direction A and perpendicularly to the plane B, by the side wall 9.3 and by a section of tank wall 2.2. Arranged at the ends are the end walls 9.6 and 9.7, which close off the interior 9.4 in the longitudinal direction A over its entire cross section. On the upper side 9.8, storage tank 9 is open, while it is closed off at the bottom by the bottom 9.2. In this case, storage tank 9 extends substantially over the entire length of the interior 2.2 of the working tank 2, and therefore the end walls 9.6 and 9.7 are each arranged just behind the end walls 2.4 and 2.5 of the working tank 2 in the longitudinal direction A. Above the open upper side 9.8 of storage tank 9, pipe section 6.2 passes through tank wall 2.1 in the longitudinal direction A, being arranged approximately in the center of the working tank 2.

To stabilize tank wall 9.4, storage tank 9 has supporting ribs 9.9, which fix the free upper longitudinal edge of the side wall 9.3 on the tank wall 2.1 of the working tank 2. Supporting ribs 9.10 are likewise arranged underneath the bottom 9.2, supporting the bottom 9.2 on tank wall 2.1. Thus, on the one hand, storage tank 9 is stabilized on the working tank 2. On the other hand, the supporting ribs 9.9 and/or 9.10 can be designed in such a way that they make an additional contribution to the stabilization of the working tank 2. On the outside of tank wall 2.1, the working tank 2 has supporting ribs 2.8 running round in a ring in order to improve the structural stability of the working tank 2.

A collecting tank 7.3 of the discharge device 7, in which the sterilizing water 5 can be collected, is formed in a lower region of the working tank 2. In the present case, the collecting tank 7.3 is designed as a half pipe closed at the ends and is attached to the outside of the working tank 2 along a bottom apex line. Corresponding outflow openings 7.4 connect the process chamber 4 to the collecting tank 7.3. In the interior 2.2, the working tank 2 can have a delivery device and/or a supporting surface for the material 3 to be sterilized or for pallets or trays carrying the material 3 to be sterilized, for example.

FIG. 4 shows a flow diagram of the essential method steps of a method according to the invention for implementation on a device 1 or 21 according to the invention.

Introducing 100 the material (3) to be treated into the sterilizing chamber 4 of the working tank 2; introducing 110 the quantity of sterilizing water 5 required for carrying out the method from the storage tank(s) 9 and/or 9′ arranged in the working tank 2 into the sterilizing chamber 4;

heated circulation 120 of the sterilizing water 5 by means of the circulating device 8 between the discharge device 7 and the feed device 6, wherein the sterilizing water 5 is heated to the desired process temperature; if necessary, cooled circulation 130 of the sterilizing water 5 by means of the circulating device 8 between the discharge device 7 and the feed device 6, wherein the sterilizing water 5 is cooled to a desired removal temperature;

transferring 140 a significant amount of the sterilizing water 5 present in the sterilizing chamber 4 into the storage tanks 9 and/or 9′ arranged in the working tank 2;

if appropriate, discharge 150 of some of the sterilizing water 5 and compensating a level in the storage tank(s) 9 and/or 9′ by feeding in additional sterilizing water 5 from the outside.

In general, the material 3 to be sterilized is removed from the sterilizing chamber 4 on conclusion of the method, whereupon the method can be carried out again, starting with step 100.

1-17. (canceled)

18. A device for carrying out a heat treatment method with a heat treatment liquid, comprising
a) a working tank, which can be dosed in a pressure tight manner, the interior of which comprises a process chamber for arranging material to be treated,
b) a feed device for feeding a heat treatment liquid into the process chamber,
c) a discharge device for discharging heat treatment liquid present in the process chamber,
d) a circulating device for circulating a quantity of the heat treatment liquid introduced into the process chamber for carrying out the heat treatment method between the discharge device and the feed device,
e) a heating device (8.4) for heating the heat treatment liquid (5),
f) a storage tank for temporarily storing substantially the entire quantity of the heat treatment liquid introduced into the process chamber for the heat treatment method,
g) a transfer device for transferring the heat treatment liquid from the process chamber into the storage tank and
h) a return device for returning the heat treatment liquid from the storage tank into the process chamber,
wherein
the storage tank is arranged completely in the interior of the working tank.

19. The device as claimed in claim 18, wherein the return device is designed in such a way that the storage tank can be connected fluidically to the circulating device via the return device, thus enabling the heat treatment liquid to be returned to the process chamber from the storage tank via the circulating device.

20. The device as claimed in claim 18, wherein the return device is designed in such a way that the storage tank can be connected directly to the process chamber via the return device.

21. The device as claimed in claim 18, wherein the return device comprises a valve device arranged in the interior of the working tank.

22. The device as claimed in claim 18, wherein the return device comprises a valve device arranged outside the working tank.

23. The device as claimed in claim 18, wherein the circulating device comprises a valve arrangement, by means of which a heat treatment medium discharged by the discharge device can be fed either to the feed device or, via the transfer device, to the storage tank.

24. The device as claimed in claim 18, wherein the circulating device comprises a heat exchanger for heating the heat treatment medium during circulation.

25. The device as claimed in claim 18, wherein the storage tank is constructed on an inner wall of the working tank.

26. The device as claimed in claim 18, wherein the storage tank can be closed off fluid tightly with respect to the interior of the working tank.

27. The device as claimed in claim 18, wherein the working tank is designed substantially as an elongate circular cylinder, and the process chamber extends along the longitudinal direction of the working tank and has a substantially rectangular cross section.

28. The device as claimed in claim 18, wherein the storage tank extends substantially over the entire length of the interior of the working tank.

29. The device as claimed in claim 18, wherein the storage tank comprises a heating device, by means of which the heat treatment liquid can be heated to prevent microbial contamination when it is stored temporarily in the storage tank.

30. A method for heat treatment with a heat treatment liquid comprising the following steps:
a) introducing material to be treated into a process chamber of a working tank,
b) introducing a quantity of heat treatment liquid required for carrying out the method from a storage tank arranged in the working tank into the process chamber,
c) heated circulation of the heat treatment liquid by means of a circulating device between a discharge device for discharging heat treatment liquid from the process chamber and a feed device for feeding heat treatment liquid into the process chamber, wherein the heat treatment liquid is heated to a process temperature,
d) transferring a significant amount of the heat treatment liquid present in the process chamber into the storage tank arranged in the working tank,

31. The method as claimed in claim 30, wherein the feed device comprises a sprinkling device for uniform sprinkling of material to be treated, which is arranged in the process chamber, and wherein, in the circulation step, material to be treated, which is arranged in the process chamber, is sprinkled uniformly with the heat treatment liquid by means of the feed device.

32. The method as claimed in claim 30, wherein, in the step of introducing the heat treatment liquid into the process chamber from the storage tank, the storage tank is connected fluidically to the circulating device via a return device, and the heat treatment liquid is introduced into the process chamber from the storage tank via the circulating device and the feed device.

33. The method as claimed in claim 30, wherein, in the step of introducing the heat treatment liquid into the process chamber from the storage tank, the storage tank is connected fluidically directly to the process chamber via a return device, and the heat treatment liquid flows out of the storage tank into the process chamber via the return device owing to gravity.

34. The method as claimed in claim 30, wherein a heat treatment liquid consisting substantially of water is used.

35. The method as claimed in claim 30, wherein after the step of transferring a significant amount of the heat treatment liquid, discharging some of the heat treatment liquid and compensating a level in the storage tank by feeding in additional heat treatment liquid from the outside is performed.
